(19) United States
(12) Patent Application Publication
(10) Pub. No.: US 2009/0091196 A1
(43) Pub. Date: Apr. 9, 2009

(54) Magnetic Power Supply Engine

(76) Inventor: Phillip Cooper, Fayetteville, AR (US)

Correspondence Address: MEREK, BLACKMON & VOORHEES, LLC, 673 S. WASHINGTON ST., ALEXANDRIA, VA, 22314, US

(21) Appl. No.: 12/036,517

(22) Filed: Feb. 25, 2008

Related U.S. Application Data
(60) Provisional application No. 60/903,296, filed on Feb. 26, 2007.

(51) Int. Cl. H02K 7/075

(52) U.S. Cl. 310/24

(57) ABSTRACT

An electric motor utilizing a plurality of linearly reciprocating magnetic elements comparable to pistons in a fluid motor and a linear-to-rotary motion translation element comprising a sinusoidal member engaging the reciprocating magnetic elements. The sinusoidal member is fixed to a rotary output shaft. Each reciprocating magnetic element has rollers for miminizing friction while engaging the sinusoidal cam and additional rollers for guiding reciprocation within the housing of the motor. In a preferred embodiment, the electric motor is a DC motor which drives an AC generator.

### CROSS REFERENCE TO RELATED APPLICATIONS

This application claims the benefit of U.S. Provisional Application 60/903,296, filed Feb. 26, 2007, entitled Magnetic Power Supply Engine, which is incorporated herein by reference.

### FIELD OF THE INVENTION

The present invention relates to electric motors and rotary appliances driven by electric motors.

### DESCRIPTION OF THE PRIOR ART

Electric motors are well known. An electric motor is essentially a rotary arrangement of magnets arranged so that application of electrical power induces reactive magnetic fields which act by attraction or repulsion or both to generate torque in an output shaft. Most electric motors are arranged to have field coils act directly on a rotatable member or rotor.

The prior art is replete with heat or fluid pressure driven piston devices which utilize sinusoidal cams, tracks, grooves, or the like to translate linear piston motion to rotary output motion. A few electrical devices have been proposed, which electrical devices utilize sinusoidal-to-rotary motion translation. However, motors employing plural linearly moving magnetically driven elements which engage a sinusoidal cam at opposing sides of the latter are not known in the prior art.

### SUMMARY OF THE INVENTION

The present invention in at least one embodiment provides an electric motor utilizing a plurality of linearly driven solenoid elements, which will be referred to hereinafter as magnetic pistons. The electric motor has a sinusoidal cam which interacts with the magnetic pistons to produce a rotary output. The rotary output drives a rotary appliance, which in one embodiment is a generator. An advantage of this arrangement is to utilize direct current from a storage battery to drive an alternating current generator, or alternator, when a usual AC power source fails.

The magnetic pistons transfer motion to a sinusoidal cam having at least relatively two high points therealong and a corresponding number of low points therealong. This characteristic enables the pistons to go through more stroke cycles than one per revolution of the output shaft of the motor. Consequently, greater power is developed at relatively low output shaft speeds than would be the case in motors in which a magnetic piston or its equivalent goes through one stroke cycle for each revolution of the output shaft. A stroke cycle signifies that a magnetic piston, starting at any arbitrary point along its reciprocating path, moves to the extreme point of travel in one direction, then to the extreme point of travel in an opposed direction, and returns to the initial starting point.

It is, therefore, an object of the invention to provide an electric motor which uses a plurality of magnetic pistons.

It is an object to increase power of an electric motor having magnetic pistons over that which would result from a one-to-one correspondence between piston stroke cycles and output shaft revolutions.

It is a further object to use magnetically activated pistons to drive a sinusoidal cam that drives an output shaft.

It is an object of the invention to provide improved elements and arrangements thereof by apparatus for the purposes described which is inexpensive, dependable, and fully effective in accomplishing its intended purposes.

These and other objects of the present invention will become readily apparent upon further review of the following specification and drawings.

### BRIEF DESCRIPTION OF THE DRAWINGS

Various objects, features, and attendant advantages of the present invention will become more fully appreciated as the same becomes better understood when considered in conjunction with the accompanying drawings, in which like reference characters designate the same or similar parts throughout the several views, and wherein:

FIG. 1 is a diagrammatic side elevational view of major internal parts of an electric motor according to one embodiment of the invention.

FIG. 2 is a perspective detail view of an embodiment of one magnetic piston, and is drawn to scale reduced from that of FIG. 1.

FIG. 3 is a perspective view of part of an electric motor according to an embodiment of the invention, shown connected to a motor driven appliance.

### DETAILED DESCRIPTION OF THE PREFERRED EMBODIMENTS

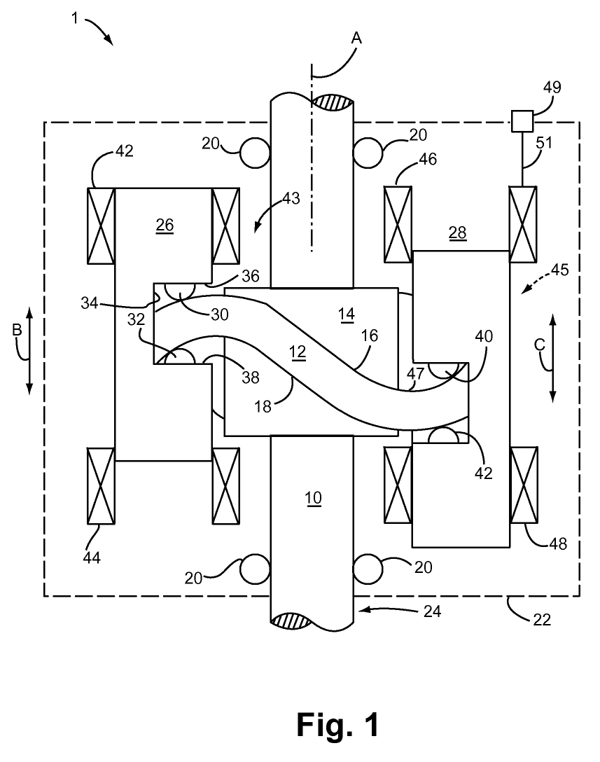

FIG. 1 of the drawings shows certain significant internal operative components of a novel electric motor 1 according to one embodiment of the present invention. An output shaft 10 having an axis of rotation A is fixed to a plate 12 by an intervening enlargement 14. These components may be fully integral with one another, or may be separate components joined in fixed relationship to the others. Plate 12 acts as a sinusoidal cam for reasons to be explained hereinafter, having a sinusoidally configured first surface 16 and a parallel, opposed sinusoidally configured second surface 18.

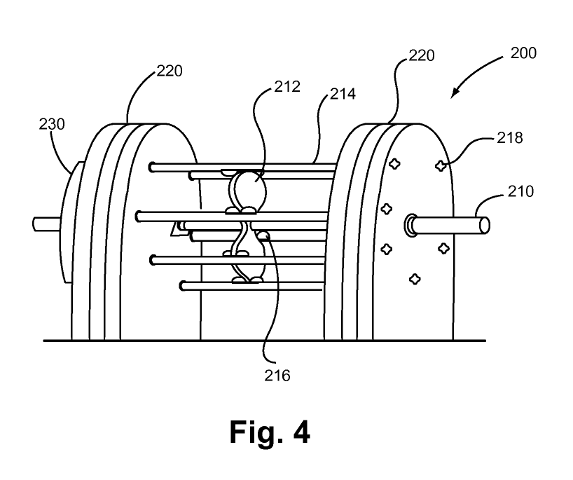

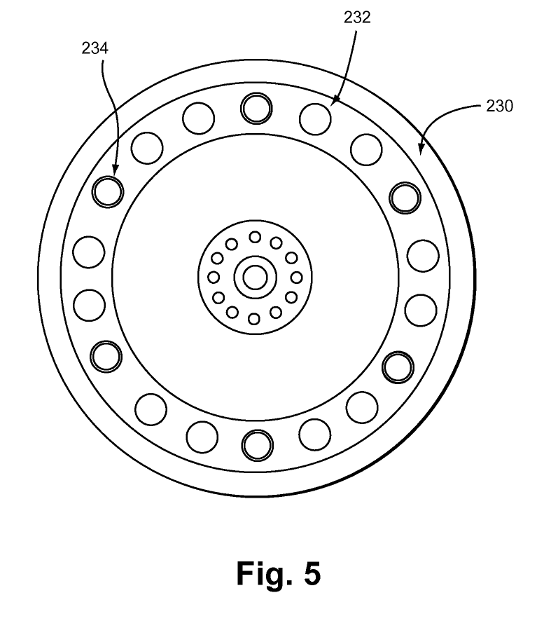

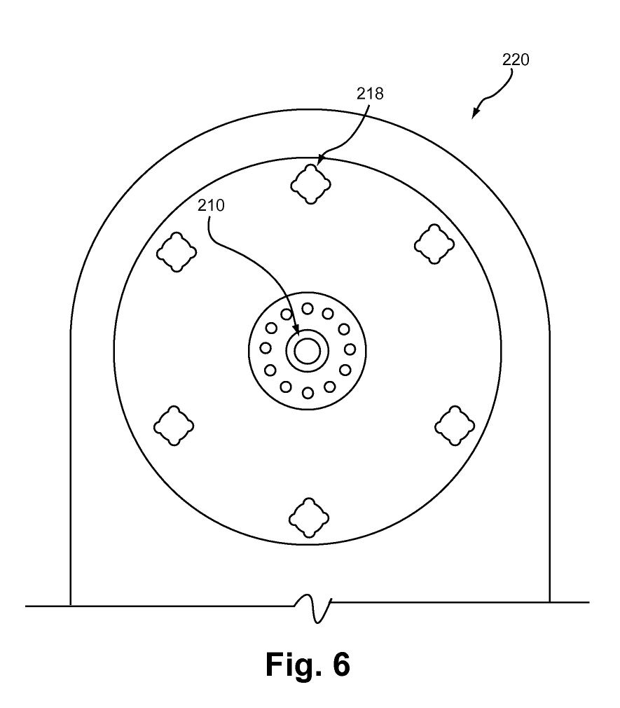

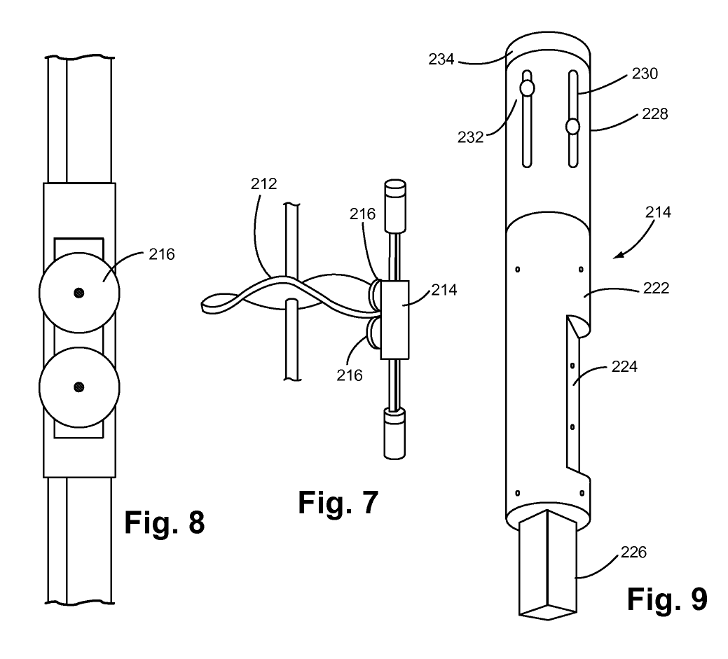

Output shaft 10 is supported on suitable bearings 20 within a housing 22. In FIG. 1, housing 22 is shown only representatively. In practice, housing 22 may take a generally cylindrical configuration, such as housing 122 of FIG. 3, or may have any other desired configuration including openings (not shown) to promote convective cooling where desired. Bearings 20 are shown representatively, and will be understood to provide both radial constraints on travel of output shaft 10 and also axial constraints or thrust control, as desired. Bearings 20 may be supported by any suitable structure such as races and the like (not shown) formed as part of housing 22. As these functions and structures are well known within the field of electric motors, further details regarding the same are omitted herefrom. It will be seen that output shaft 10 projects outwardly from housing 22 at its distal end 24. Preferably, distal end 24 includes a keying groove, a flange, or any other known structure (none shown) to facilitate connecting output shaft 10 to an appliance to be driven by motor 1.

Motor 1 includes a plurality of magnetically moved pistons 26, 28 which are disposed to reciprocate along linear paths located within housing 22. As depicted in FIG. 1, each magnetic piston 26 or 28 can move vertically (as indicated by arrows B and C) within limits. Magnetic piston 26 is shown near the upper limit of its travel within motor 1, and magnetic piston 28 is shown near the lower limit of its travel within motor 1. As is well known to those skilled in the art, the relative position of each piston will depend on the number of pistons distributed about the cam and the number of peaks and valleys in the cam. Here, as shown in the FIG. 3, there are three pistons shown surrounding a sinusoidal cam plate 12 having two peaks. Greater or fewer numbers of pistons and peaks can be used, with a six piston or twelve piston configuration being preferred with a cam having two peaks.

Each piston 26 or 28 can move to between a top dead center and a bottom dead center to cover a distance defined by the highest peak and lowest valley of the sinusoidal cam. In this way, the cam defines the linear path for each piston 26 or 28.

Each piston has an upper bearing and a lower bearing. By way of example, piston 26 has an upper bearing 30 and a lower bearing 32 and piston 28 has bearings 40, 41. Preferably the bearing are low friction non-ferrite materials such as felt, polyurethane, NEOPRENE or TEFLON™ or similar material that will not interfere with the magnetic piston. Similarly, other bearings shown (e.g., 56, 58, 60, 62) can be made of non-metals to provide low-friction retention and spacing of the parts without interfering with the magnetic portions of the motor. The piston may be magnetic or ferrous, or may be made of aluminum or other non-magnetic material and incorporate magnets, ferrous materials or magnetic materials at its top and/or bottom portions.

As employed herein, orientational terms such as “up”, “upper”, “down”, “lower”, “vertical”, “horizontal”, etc., refer to directions as seen in the depictions of the various drawing figures which are referenced in textual description. Obviously, these orientations change with the position of a motor (e.g., motor 1) within its environment. Therefore, it will be understood that these orientational terms are introduced for semantic convenience, and should not be taken as literal conditions for practicing the invention.

Plate 12 has an upper sinusoidal surface 16 and a lower sinusoidal surface 18. When plate 12 is assembled to piston 26 as seen in FIG. 1, plate 12 partially occupies a recess 34 formed in piston 26. Upper bearing 30, which is mounted to an upper wall 36 partially defining recess 34, engages upper sinusoidal surface 16 of plate 12. Lower bearing 32, which is mounted to a lower wall 38 partially defining recess 34, engages lower sinusoidal surface 18 of plate 12. It will be appreciated that vertical movement of piston 26 induces rotation of plate 12 as pressure of linear motion of piston 26 is transferred to plate 12, and ultimately to output shaft 10, by bearings 30 and 32. Piston 28 and the its associated bearings 40 and 41, as with other pistons (not shown), if provided, essentially repeat structural and functional characteristics of piston 26, and need not be further described hereinafter.

Plate 12 serves as a linear-to-rotary motion translation apparatus, given its relationship to magnetic pistons 26 and 28, which are arranged to bear against plate 12 when moving along their linear paths. As configured, plate 12 causes pistons 26, 28 to undergo two stroke cycles each for each revolution of output shaft 10. This is because sinusoidal surfaces 16, 18 of plate 12 of FIG. 1 each define a first high point 43 (“peak”) and a second high point 45. High points 43, 45 are separated by intervening low points (“valleys”) including low point 47 and a second low point not visible in FIG. 1, but located diametrically across plate 12.

Pistons 26 and 28 reciprocate along their respective paths responsive to magnetic fields. These magnetic fields are induced by stationary magnetic field inducing elements supported within housing 22. These field inducing elements may be coiled electrical conductors or coils 42, 44, 46, and 48. Coils and ferromagnetic cores, where desired, are well known and need not be set forth in greater detail. Pistons 26, 28 may be fabricated from a ferromagnetically responsive material such as iron or steel, may have incorporated therein a ferromagnetically responsive component, or may have a magnet integrated therein. Magnets may be ferrous or non-ferrous, such as aluminum nickel cobalt alloys. Coils 42, 44, 46, 48 are supplied with electrical power by any suitable source of electrical power and switching apparatus, the power and switching apparatus being shown representatively as 49 in FIG. 1, which may include an electrical control module for controlling the timing and switching. The power source and switching apparatus may be integral, as literally depicted in FIG. 1, or may be separate. For example, the switching apparatus may comprise contacts and limit switches (neither shown) located within housing 22, while the power source may comprise a remote battery (not separately shown) and a circuit 51 connecting the power source to coils 42, 44, 46, 48. Field control circuits and switching apparatus are well known in the electrical arts, and any suitable circuitry and switching apparatus known in the prior art may be incorporated into motor 1 and its supporting apparatus. Of course, although depicted by a single line in FIG. 1, circuitry will be understood to include conductors which are sufficient in number and arrangement to satisfy operative requirements of the functions they are described as providing.

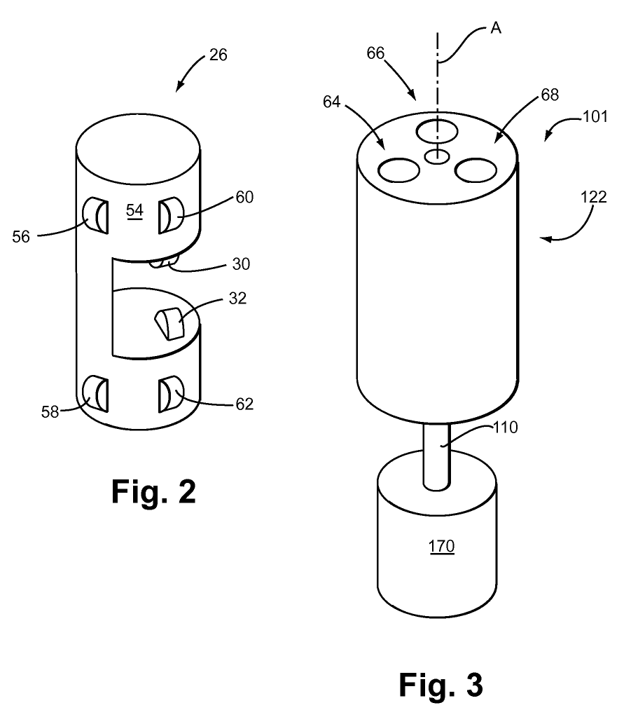

Turning now to FIG. 2, further structural features of piston 26 are set forth. Piston 26 has an external surface 54. A plurality of guide rollers 56, 58, 60, 62 are disposed at external surface 54. Guide rollers 56, 58, 60, 62 serve to guide piston 26 as it moves in its linear path by engaging a guide surface formed in housing 22 by rolling contact therewith. The guide rollers may be non-rotating, low friction spacers made of felt, TEFLON™, or other non-ferrous materials.

As seen in FIG. 3, housing 122 of motor 101, which is generally similar in operating principles to motor 1, has three cylindrical openings 64, 66, 68. Each opening 64, 66 or 68 houses one piston, preferably of the type shown in FIG. 2. In the embodiment of FIG. 3, the cylindrical surfaces of cylindrical openings 64, 66, 68 serve as guide surfaces which constrain their associated pistons to move only linearly, parallel to axis A of rotation of output shaft 110. The pistons associated with housing 122 are preferably similar to piston 26 of FIG. 2. Rollers of the pistons contact the cylindrical surfaces of cylindrical openings 64, 66, 68. The housing is preferably made from aluminum to minimally interfere with magnetic fields. The length of the openings should be sufficient to allow the pistons to complete their entire linear travel without striking a wall or endplate. Preferably a space of 0.040 inches of spacing is provided between the walls and the piston at its top most and bottom most position. Preferably, the cylinder is appropriately vented to facilitate movement of the piston without pressure buildup within the cylinder during travel of the piston. A space may be provide between the sidewalls of the piston and the housing of preferably ⅛ inch to facilitate air flow past the cylinder as it travels, with guides (e.g. . . . , 56, 58, 60, 62) maintaining proper orientation of the piston within the housing. Since there is no combustion in the motor, piston rings and the like are not required.

Guide surfaces, which define the linear paths of their associated pistons, may take forms other than cylindrical. For example, grooves or tracks (neither shown) may be provided to guidingly receive the rollers of the pistons. The cross sectional configuration of openings corresponding in the function of receiving magnetic pistons, and also of magnetic pistons, may be other than circular.

FIG. 3 shows a further feature of motor 101. Output shaft 110, which is generally similar to output shaft 10 of FIG. 1, is connected to a rotatably driven appliance. Motor 101 is a DC motor with its stationary magnetic field inducing elements electrically connected to a battery or other suitable source of direct current. The driven appliance may be an alternating current generator 170, which converts the rotary motion of the shaft into alternating current electricity. However, connection of an AC generator to the output shaft of the DC motor is not necessary to practice the invention. This arrangement enables, for example, AC power to be provided to occupied premises (not shown) where utility electrical power has failed, and where a storage battery is the only power source available, so that operation of AC electrical devices is enabled despite loss of utility AC power. Standby batteries are well known measures for accommodating transient power failures, and their construction and connection need not be detailed further.

The present invention is susceptible to modifications and variations from the embodiments which have been shown and described. For example, the novel motor may be arranged to be AC operated. The number of pistons and of high and low points of the sinusoidally configured plate may be varied to suit.

Rollers and roller bearings may be replaced by non-rotatable bearing devices, or preferably non-metallic, no-rotatable bearings such as felt or TEFLON™.

A motor output shaft such as output shafts 10 and 110 may be arranged to project from both sides of their respective motors 1, 101, if desired. The output shaft may be used to provide motive force to drive, for example, wheels of an automobile to convert DC power to rotary motion for instance in an electric car or a vehicle having an energy recovery systems (“hybrid vehicle”).

The output shaft could also be used to generate DC power to trickle charge the power source. If the motor is operated in constant motion, it may be desirable to convert any energy that would otherwise be wasted into a charge sent back to the battery. Additionally, since most generators and alternators can be reversed to convert one to the other, the motor could be used as a generator to charge a battery instead of as a motor run from a battery.

It will also be appreciated that surfaces 16, 18 of plate 12 need not be purely sinusoidal. For example, surfaces 16, 18 may include a straight portion intervening between transitional curved portions.

As best seen with reference to FIGS. 4-9, further embodiments of the invention are shown. FIG. 4 shows an electric motor 200. The motor has a central shaft 210 connected affixedly to a cam 212. This cam may be sinusoidal or similar pattern having peaks and valleys. A number of pistons 214 are located proximate the cam 212. Preferably an even number of pistons are distributed evenly about the cam. In FIG. 4, six pistons are shown, but any number can be provided depending on the power output and force distribution desired. Since each piston moves independently of each other, the only theoretical limitation on the number is the amount of space provided around the cam to physically place the pistons in contact with the cam. However, consideration must also be made that at each position, a motivating magnet must be properly aligned with the piston, and therefore the actual number of pistons that can surround the cam is much smaller as magnets that were too close together would interfere with each other or with magnets on the other pistons as discussed below.

Each cam as shown in FIGS. 7 and 8 has a number of rollers or followers 216 configured on either side of the cam to ride along the profile of the cam 212. As the cam rotates and a peak is presented to the piston, the pistons will rise. Or conversely, as the piston rises, the cam will rotate to a position where the profile of the cam matches the height of the piston rollers. In this way, the cam can drive the pistons or the pistons can drive the cam. In this way, rotary motion can be converted to reciprocal motion or vice versa. One skilled in the art would appreciate that other follower mechanisms could be used to match the motion of the piston and cam, with the rollers providing a simple way of allowing the cam to move past the piston with the minimum amount of friction. However, the cam or a portion extending from the cam could ride in a slot in the piston or the piston could have an arm that was designed to ride in a slot, groove of the cam to allow the cam and piston to move as a function of the movement of the other.

The main shaft 210 is secured into two opposing housings 220. A bearing (not shown) may be provided in the housing to allow to locate the shaft within the housing while allowing the shaft to rotate with minimum friction. However, depending on the speed on the shaft and the housing material, bearings may not be required in all applications.

The housings also secure opposite ends of the pistons in mating holes 218 through the housing. Unlike the pistons, however, the piston shafts preferably do not extend all the way through the housings to the area beyond the housing, but are limited to travel within the housing. The thickness of the housing may be selected based on the total travel of the pistons, which is related to the amplitude of travel of the cam. If the housing is thicker than the cam amplitude, then the ends of the pistons can travel within the housing without accidentally releasing therefrom. However, as discussed below, the ends of the piston may extend beyond the walls of the housing.

The pistons are shown as having a substantially cylindrical body 222 where the rollers 216 are connected. However, the shape is not critical to the operation of the invention, but is preferred for strength and ease of manufacture. A cut out portion 224 is also shown to on the body to accommodate all or a portion of the rollers and to locate the cam plate closer to the central axis of the piston. Either end of the piston may include a reduced section to lighten the piston while still maintaining the structural integrity. As shown in FIGS. 8 and 9, the ends of the piston may include a square neck section 226 connecting the out ends with the central body 222. The ends of the piston 228 that ride within the housing are preferably cylindrical to be easily maintained within a matching shape opening in the housing. However, other shapes can be used so long as the housing and the piston ends have complementary shapes. As shown in FIG. 9, the piston ends may include a number of grooves 230 for containing ball bearings 232 for nonfrictionally maintaining the pistons aligned in the holes in the housing. A number of bearing slots are

The very ends of the piston shaft include magnets 234 (FIG. 9). Preferably the magnets are unipolar, permanent magnets having one magnetic pole on each side of the magnet. The magnets on the pistons preferably include a “North” pole facing outwardly. Each end of the shaft includes a faceplate (230). The faceplate on the right of FIG. 4 has been removed to show the details of the housing 220. FIG. 5 shows the detail of a faceplate (“endplate”) according to the invention.

A number of slots 232 on the endplates are available to receive magnets. One magnet 234 is provided for each peak on the cam, and one for each valley on the cam. Preferably there is one piston for each peak and each valley as well so that there are no gaps in driving the pistons as the endplate rotates. The end plate must be aligned properly with the cam such that the magnets in the end plate appropriately force the pistons in the proper direction on the cam. In this embodiment, six magnets 234 and six piston 214 are provided, though the ratio could be changed. These magnets are preferably permanent magnets, but electromagnets may be substituted as described below. The magnets are located on the end plate such that as the magnet begins to approach a piston, a magnet in the end plate closest to the piston will contain a magnet having the same polarity as the near end of the piston. The opposite end of this same piston will have a polarity that is the opposite the polarity of the magnet in line with the piston in the opposite end plate. In this way, when at any one time a piston is being motivated against a near end and drawn towards the far end. This provides significant motivational force to move the piston axially away from one endplate towards the other. As the piston travels, the roller followers 216 move against the cam causing the cam to rotate out of the way of the piston, thereby converting reciprocal motion to rotary motion. As the cam rotates, the shaft connected affixedly to both endplates and the cam causes the endplates to rotate to move the magnets out of alignment with the piston. After the piston has reached its full travel away from the endplate towards the other end plate, since the endplate has alternating polarity magnets, the endplate will have rotated enough to bring opposite polarity magnets in near alignment with the piston. Now the piston will be urged in the opposite direction to return towards the original position under the reversed polarity of the aligning magnets. The endplate now furthest from the piston will have the same polarity as the adjacent piston end drawing the piston back towards the end plate will the opposite endplate and opposite piston end will have a same polarity to drive the piston away from the endplate closest to the piston end. In this way three piston are being driven towards one endplate while three pistons are being driven towards the opposite end plate.

In a further embodiment, the device could be made using electromagnets instead of permanent magnets. In this case, it would not be necessary to have the endplates rotate, as current could be used to reverse the polarities of the magnets in the fixed endplates to motivate the pistons at the proper time. A time mechanism which is synchronized with the cam or cam shaft 210 could be used to time the polarity changes of the magnets. Alternately, the travel of the pistons could be used to affect switching of the magnets, however this may be more complicated to prevent the switching of magnets from being out of synch with each other. A 12 volt battery, for example, could be used to power the electromagnets by converting the DC power to AC to power the magnets with the proper alternating current.

One effect of the output shaft and input shaft being coupled is that the device will be self building, as the magnets motivate the cam to move faster, the cam will motivate the magnets to move faster. This will build to a speed determined by the power of the magnets and the amount of drag on the device. While the output shaft and/or the input shaft could be connected to any device, it is envisioned that a generator could be connected to the device to generate electricity. One skilled in the art would appreciate that one protruding shaft could be remove resulting in only a singular shaft used for output, depending on the space requirements or other requirements of the motor.

Other embodiments and variations can also be used, and each element of object of the invention need not be in each embodiment. The invention is not to be limited by the description of the specific embodiments above, but only by the accompanying claims.

I claim:

1. An electric motor having
a housing,
a plurality of stationary magnetic field inducing elements supported within said housing,
a plurality magnetically moved pistons which are disposed to reciprocate along linear paths located within said housing responsive to magnetic fields induced by said stationary magnetic field inducing elements, and
a linear-to-rotary motion translation apparatus supported by said housing, including an output shaft projecting from said housing and a sinusoidal cam fixed to said output shaft, wherein all of said magnetically moved pistons are arranged to bear against said sinusoidal cam when moving along said linear paths.

2. The electric motor according to claim 1, wherein
said sinusoidal cam comprises a plate which has a sinusoidally configured first surface and an opposed sinusoidally configured second surface, and
each said magnetically moved piston has a first roller element supported thereon and a second roller element supported thereon, and said first roller element contacts said first surface of said plate and said second roller element contacts said second surface of said plate.

3. The electric motor according to claim 1, wherein
said housing has a guide surface for each said magnetically moved piston, which said guide surface defines said linear path for each said magnetically moved piston, and
each said magnetically moved pistons has an external surface and a plurality of guide rollers disposed at said external surface and arranged to engage said guide surface such that each said magnetically moved piston moves along its respective said linear path by rolling contact with its respective said guide surface.

4. The electric motor according to claim 1, wherein said sinusoidal cam defines two relatively high points therealong and two intervening relatively low points therealong.

5. The electric motor according to claim 1, further comprising an appliance rotatably drivingly connected to said output shaft.

6. The electric motor according to claim 5, wherein said stationary magnetic field inducing elements are electrically connected to a source of direct current arranged to establish a magnetic field capable of causing said magnetically moved pistons to reciprocate along said linear paths located within said housing, and said appliance comprises an alternating current generator.
